(19) United States
(12) Patent Application Publication
(10) Pub. No.: US 2024/0125070 A1
(43) Pub. Date: Apr. 18, 2024

(54) TRANSPORT CAP OF A SEA FOUNDATION PILE, INSTALLATION CRADLE OF THE TRANSPORT CAP OF A SEA FOUNDATION PILE, METHOD OF INSTALLING A TRANSPORT CAP INSIDE A FOUNDATION PILE, TOWING SET OF SEA FOUNDATION PILES, METHOD OF SEA TOWAGE FOUNDATION PILES AND PREPARATION OF A FOUNDATION PILE FOR INSTALLATION IN THE SEABED

(71) Applicant: Fairplay Towage Polska Sp. z o.o. Sp. k., Gdynia (PL)

(72) Inventors: Miroslaw Wiater, Szczccin (PL); Arkadiusz Ryz, Police (PL)

(73) Assignee: Fairplay Towage Polska Sp. z o.o. Sp. k., Gdynia (PL)

(21) Appl. No.: 18/547,365

(22) PCT Filed: Feb. 24, 2022
(86) PCT No.: PCT/PL2022/000012

§ 371 Date: Aug. 22, 2023

(30) Foreign Application Priority Data
Feb. 25, 2021 (PL) P.437126

(51) Int. Cl. E02B 17/02; B63B 77/10; E02B 17/00; E02D 13/00; F16L 55/134

(52) U.S. Cl. CPC E02B 17/02; B63B 77/10; E02B 17/0013; E02D 13/00; F16L 55/134; E02B 2017/0039

(57) ABSTRACT

The pile plug (1) has independent buoyancy, high displacement and a rigid structure of the skeleton (2) and a flexible sheath (3) at least on the side surface of the plug body, while the flexible sheath constitutes an airtight container equipped with pneumatic valves (4). The sheathing material (3) of the plug (1) can be made of a material with a high friction coefficient in relation to the pile material selected from the group: natural rubber, synthetic rubber, polyurethane. Inside the cap (1) there is a pile venting pipe (14) closed with a pile venting valve (15), which connects the space inside the pile with the surroundings. Preferably, the cap (1) has a ballast load (16) internally for positioning the plug with respect to the pile and for balancing the cap horizontally and also preventing unfavourable rotation of the pile.

### CROSS REFERENCE TO RELATED APPLICATION

This application is a national stage entry of PCT/PL2022/000012 filed Feb. 24, 2022, under the International Convention and claiming priority over Poland Patent Application No. P.437126 filed Feb. 25, 2021.

### FIELD OF THE INVENTION

The subject of the invention is the transport cap of a sea foundation pile used for air-tight sealing of the pile during towing to its destination. The invention also relates to the installation cradle of the transport cap of the sea foundation pile and the method of installing the transport cap inside the foundation pile. Moreover, the subject of the invention is a towing set of sea foundation piles, a method of towing foundation piles over the sea surface and a method of preparing a foundation pile for installation in the seabed.

### BACKGROUND OF THE INVENTION

When building offshore wind farms, it is necessary to provide foundation structures for the wind turbines being installed. For sea depths up to 50-60 m, the simplest and most popular solution for windmill foundation are monopiles—steel pipes with a diameter of up to about 10 m and a length of up to about 100 m, embedded in the ground with a crane and a vibro hammer head, operating from a pontoon or a ship (Wind Turbine Installation Vessel). The delivery itself can be made on board the ship, on towed pontoons/barges, or by direct towage (common name: wet towage) of a floating monopile.

The method of direct towage of a floating pile consists in hermetic sealing of the monopile on both ends by installing mechanically sealed caps. When closed, the pile is towed to the installation site, lifted with a crane, unsealed, partially submerged, lowered to the bottom of the sea area and driven into the bottom. The caps are taken back by the tug and the process is repeated. Each pile is towed separately by one tug.

The caps used so far do not have independent buoyancy, and the cap sizes required by the size of the pile prevent simultaneous towing of several piles because the caps will not fit on the deck of the tug boat on the way back.

The patent description U.S. Pat. No. 4,373,835 discloses a removable closure plate for sealing in an elongated, sea-floating, hollow, tubular column structure. The closure plate is adapted to be easily removable and includes a centrally located pulling member detachably connected to the top and permanently connected to the bottom of the closure plate, the closure plate being releasably connected around its periphery to the inner surface of the column. A pulling element passing through an opening in the upper part and further releasably connected to the upper part in a liquid impermeable manner and rigidly connected to the lower part, the lower part having a plurality of openings therein. The closure plate has a circuit releasably connected to the interior surface of the column to form a liquid-impermeable seal, and means for detaching the closure plate from the column by exerting a force on the traction member sufficient to first break the seal around the top portion and by maintaining a force sufficient to break the seal between the closure plate and the column.

A marine structure is known from the patent GB2038910, which consists of: a mantle having a displacement compartment defined by the arms of the mantle; breakaway closure defining the lower end centres of the mentioned floating chamber elements, while the mentioned breakaway closure elements can be torn by the coverings hitting their upper lateral centres, when the elements with the mantle arms are substantially vertical. The breakaway closure centre has convex side elements and a concave upper side centre; a plurality of circumferentially extending generally extending radially weakened zones in the hood centres operating to define radially extending rupture zones when the cap centre is impacted against the concave upper side by the pile driving devices The cup-shaped cap, after impact during driving, tears along generally extending radially weakened zones.

From the U.S. Pat. No. 4,576,522 a breakaway closure is known for use on annular elements of marine structures. The closure includes: a membrane; a pair of flat annular plates holding a membrane therebetween, one of the flat annular plates being attached to the mentioned annular element; and a membrane tear-out assembly for removing membrane parts from between the pair of flat annular plates. The knockout assembly includes: a pull base, a broken eye bolt; and a rip line, one end of which is attached to a knockout eyebolt and the other end of which is attached to the knockout base.

Placing the caps inside the pile, due to the weight and size of the cap, requires the use of considerable forces while maintaining the precision of assembly. In the art to move heavy loads, especially large objects, a swing-like motion along a curved line is often used, and the devices used for this purpose are referred to as cradles. In marine technology, cradles are used, for example, for launching ships.

The U.S. Pat. No. 4,826,355 includes a method of transporting and carrying heavy cargo on the high seas to a fixed structure. The cargo is loaded onto the self-elevating platform which is placed close to the fixed platform. The deck is raised from the self-elevating platform to the level of the fixed platform. The cargo moves on the fixed platform by means of a cradle mounted on blocks equipped with adjustment lifts. The blocks work with the sliding guides. The two platforms are connected with a guide.

A system for loading and unloading heavy packages is known from the U.S. Pat. No. 5,183,376. A system for transporting a heavy package from a ship to a quay or similar loading site uses a device for transporting the package in a vertical direction and a device for transporting in a horizontal direction. The load-bearing element in which the package is placed, is alternately lifted and lowered by a set of lifting devices. The load-bearing elements are supported separately and alternately on the foundation by climbing systems. The load-bearing elements are moved by a gradual lifting motion or a gradual lowering motion.

The U.S. Pat. No. 5,419,657 discloses a method and a device for transferring a structure from a lifting platform to a fixed platform. The structure is placed by means of a cantilever beam which is connected in such a way that it can be divided into a swing part and a base part to reduce the influence of the weight of the cantilever beam on the fixed platform. The cantilever beam may be provided with a connection section that allows the distal part of the shuttle on which the functional package rests to be detached.

The towing of ships sailing on the sea surface is a specialized field of technology for sea operations. Different solutions are used depending on the towed object. Whether it is a damaged ship that cannot be steered, or it is an unsteady wreck or a seagoing structure.

The towing-lines used in the sea towing technique are usually made of steel ropes or chains, often with ship's anchor chains. Another type of tow are ropes made of natural or synthetic fibres with adequate tensile strength and sufficiently low elongation. In most cases, the crew should be present on both the tug and the towed ship. Towing non-ship floating offshore structures often precludes direct operation of the towed element, also due to the lack of steering gear.

The patent GB2221276 discloses a method of towing prefabricated pipelines for the transport of oil or gas for installation in a marine environment. The pipelines are along their length equipped with a plurality of connected or flexible, relatively light weights which generate a lifting force during the towing movement.

Pipelines are also equipped with one or more ballast through-tubes for ballasting purposes.

In the previously known solutions, the method of preparing a foundation pile for installation in the seabed consists in suspending the upper end of the pile on a crane located on a ship or pontoon, unsealing the inside of the pile and lowering the lower end of the pile to the seabed. The method of unsealing is related to the construction of the pile closure, which makes the pile buoyant. Closure—a cap, which is a single-use element, can be opened by destroying it. From the U.S. Pat. No. 4,212,563A a marine structure is known, which consists of a shell with buoyant chambers defined by a support. The breakaway closure forms the lower end of the floating compartment. The breakaway closure can be broken by striking its upper side. A plurality of circumferentially distributed, radially weakened zones in the cap define rupture zones when the cap hits a pile on its concave upper side. The cup-like cap, when struck in a pile, breaks along the weakened zones to form multiple triangular segments on the cap. In the case of reusable caps, it must be dismantled and brought to the ship's deck. The U.S. Pat. No. 4,373,835 includes a system of a removable closure plate providing a liquid-tight closure in an elongated, sea-floating, hollow, tubular column. The closure plate is adapted for easy removal and includes a centrally located pulling element releasably connected to the upper and permanently connected to the bottom of the closure plate, the closure plate being releasably connected around its periphery to the inner surface of the column.

### SUMMARY OF THE INVENTION

The essence of the invention is a pile plug (1) with independent buoyancy and high displacement with a rigid structure of the skeleton (2) and flexible sheathing (3) at least on the side surface of the plug body, while the flexible sheathing constitutes an airtight container equipped with pneumatic valves (4). Preferably, the flexible sheathing is made of an elastomeric material with elastic reinforcement of fibers selected from the group of fibers: metal, textile, carbon or glass, while the metal fibers can be made of steel or another metal, and the textile fibers can be made of natural or synthetic fibers. The elastomeric material of the shell (3) of the plug (1) can be made of a material with a high friction coefficient in relation to the pile material selected from the group: natural rubber, synthetic rubber, polyurethane. An advantageous solution is that the plug (1) has a flexible side surface (5) and spherical flexible bottoms (6) provided with towing eyes (7). Another advantageous solution is that the cap (1) is provided with rigid bottoms (8) at its ends, the bottom being flat (9), conical (10) or spherical (11). Inside the plug (1) there is a pile venting pipe (14) closed with a pile venting valve (15), which connects the space inside the pile with the surroundings. Preferably, the plug (1) has a ballast load (16) internally for positioning the cap with respect to the pile and for balancing the cap horizontally and also preventing unfavorable rotation of the pile.

The pneumatic valves (4) of the plug (1) includes:
a main fill and drain valve (12);
a safety valve (13);
the control of the main valve (12) may be manual or pneumatic.

### BRIEF DESCRIPTION OF THE DRAWINGS

The objects of the invention are shown in the examples and in the drawing in which:

FIG. 1 shows a cross-section of a cap with a completely flexible sheathing;

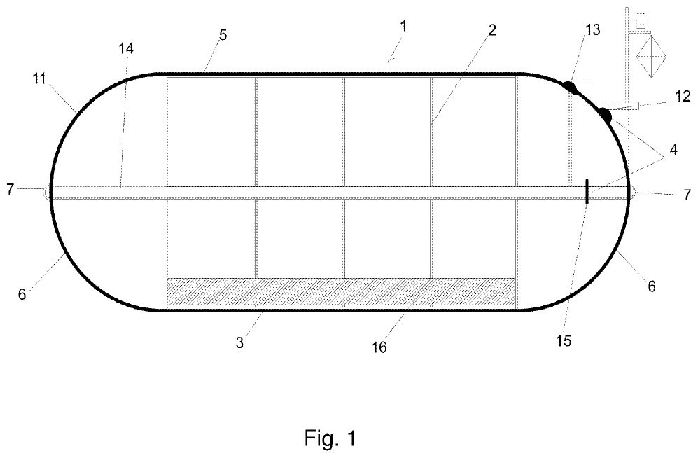

FIG. 2 cross-section of a cap with flexible side surface and rigid conical bottoms;

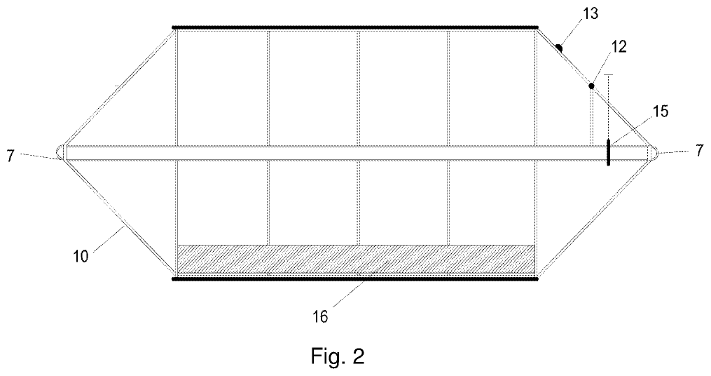

FIG. 3 cross-section of a cap with a flexible side surface and various rigid bottoms;

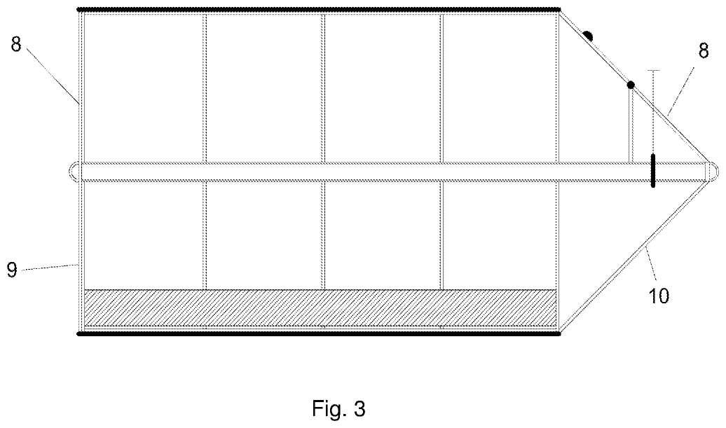

FIG. 4 shows a longitudinal section of the installation cradle;

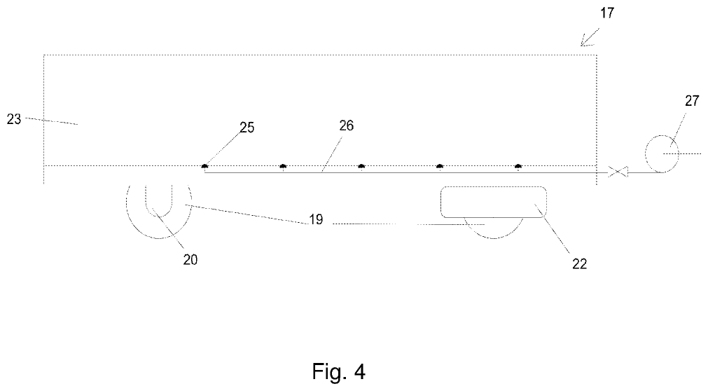

FIG. 5 front view of the installation cradle with the plug installed;

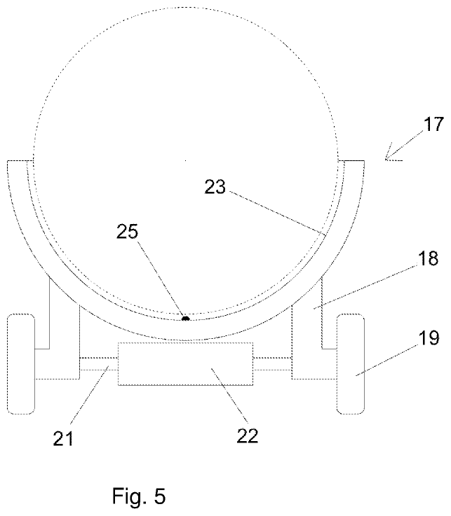

FIG. 6 diagram of the installation process of the plug in the pile;

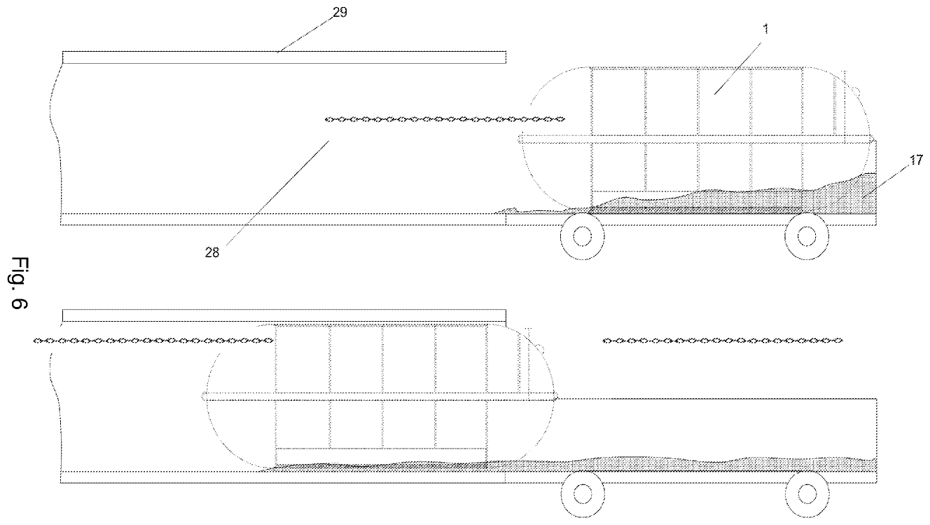

FIG. 7 shows a longitudinal section of the towing set;

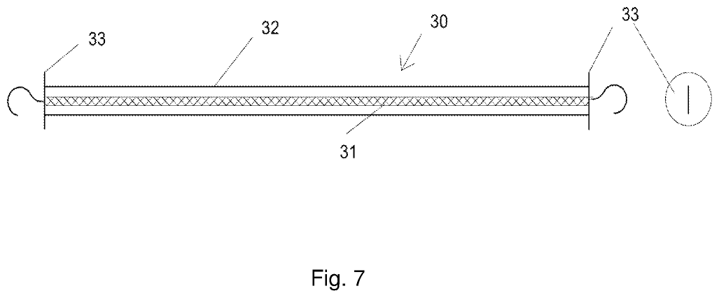

FIG. 8 longitudinal section of the pile with the plug installed:

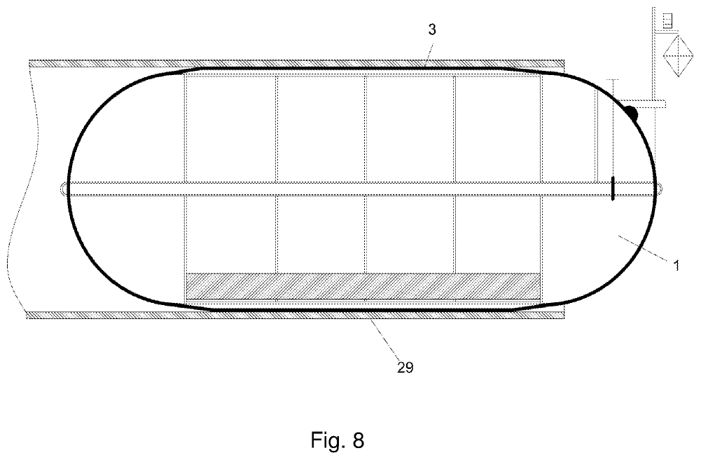

FIG. 9 longitudinal section of a towage set of piles with installed plugs; and

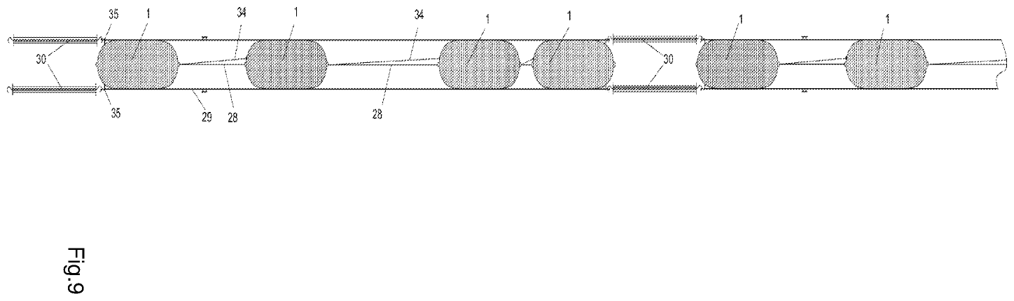

FIG. 10 consecutive phases of preparation of the foundation pile for installation in the seabed.

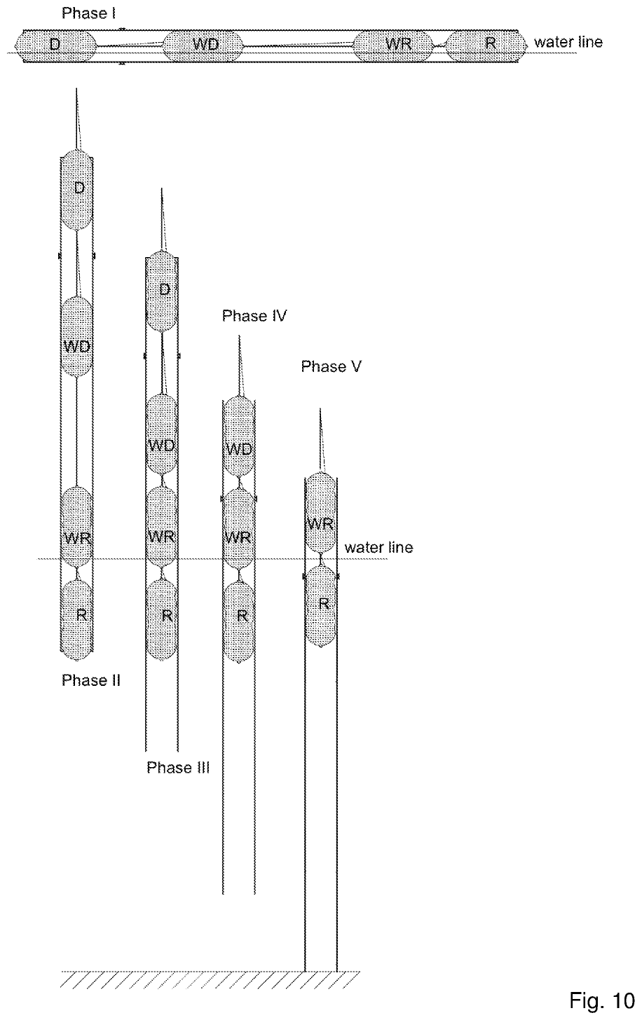

### DETAILED DESCRIPTION OF THE INVENTION

The rigid structure of the skeleton (2) of the plug (1) is placed inside the sheathing (3) and is made of metal sections in the form of a truss, to which the ballast (16), vent pipe (14) and the edges of the base (6) of the sheathing (3) are attached.

The plug (1) according to the invention has its own buoyancy, it can be towed on the way back by the tug without having to take it on board, which allows simultaneous towing of several piles to the destination and towing several caps (1) on the way back.

The installation cradle (17) according to the invention has a chassis frame (18) with a wheeled undercarriage (19) in which at least one pair of wheels is swivel. Preferably, a swivel pair of wheels is connected to the steering system (20).

Preferably, one pair of wheels is connected to the drive train (21) with the drive motor (22). On the chassis frame (18) there is a cradle (17) bed (23) in the shape of a fragment of a cylindrical surface with the inner side of the cylinder facing upwards. The internal diameter of the cylindrical surface is equal to the internal diameter of the pile (29) in which the cap (1) is to be installed, and the height of the cylinder is not less than the length of the installed plug (1). On the inner surface of the cylindrical bed (23) there is at least one water nozzle (25) fed from the water line (26) together with the pressure pump (27). Preferably, the water installation (26) with a pressure pump is an integral part of the installation cradle (17).

The essence of the pile cap installation method is that the installation cradle (17) with the bed diameter (23) equal to the pile diameter (29) is placed axially at the pile base (29), and in the bed (23), using a known method, using any lifting device the pneumatic (1) of the pile (29) is placed. Air is pumped into the (1) to a pressure not lower than 10% higher than the actual atmospheric pressure surrounding the (1). Water is pumped into the water installation (26) and the water flow through the nozzles (25) is started. When the water pumped through the nozzles (25) begins to flow into the pile (29), the cap (1) is left to stabilize its position and moves into the pile (29) and increases the pressure inside the plug (1) to tightly fill the inside of the pile (29) with a plug (1). Preferably, a hydraulic cylinder is used for shifting. Another advantageous solution is when a flexible towing-line (28) is used to move the cap (1) into the pile, through which the cap (1) is pulled from the end of the pile (29) opposite to the cradle (17).

The installation cradle allows the caps to be placed inside the pile using relatively low forces in relation to the plug size. The water eliminates the frictional forces of the cap plating against the internal surfaces of the pile. The use of buoyancy forces almost automatically orientates the plug to the correct position thanks to the use of ballast. It is important due to the access to the cap's pneumatic installations, but also for the stable position of the pile during the towing process, which is necessary due to the need to place navigation marks on the towed sets.

The essence of the towing set according to the invention is that the towing set (30) is a steel tendon (31) covered with a cylinder-shaped elastomeric sheath (32). Preferably, the steel tendon is made of a steel rope. Another advantageous solution is a steel chain tendon. The cylindrical cover (32) is made of a flexible material. Preferably, the cover (32) is made of rubber. Another advantageous solution is that the sheath (32) is made of polyurethane. The elastomeric material of the sheath (32) may be fiber reinforced. The wall thickness of the cylinder and possible reinforcement make the shell (32) very rigid. At the ends of the tendon (31) of the towing set (30), there are shield (32) bumpers (33). The stops are preferably in the form of a disk with an outer diameter greater than the outer diameter of the shield (32). The tendon (31) has at its ends any known catch elements in the form of hooks or shackles enabling the towing set (30) to be attached to the tug and the towed pile on the other side.

The essence of the method of towing the foundation piles on the sea surface is that 4 pieces of plugs (1) connected with each other by a flexible towing-line (28) and a valve control cable (34) are introduced into the foundation pile (29) by means of an installation cradle (28). The plugs (1) are placed in pairs near the ends of the pile (29). The pressure inside the plug (1) is increased until the inside of the pile (29) is tightly filled. At one end of the pile (29), at least 1 towing set (30) is attached to the hitch (35), the pile is watered and the other end of the towing assembly (30) is attached to the tug. At the other end of the pile (29), at least 1 towing set (30) is optionally attached to the hitch (35), the other end of which is attached to another towed pile provided with plugs (1) and launched. A set of piles (29) connected by semi-rigid towing sets (30) is towed to the installation site.

The essence of preparing the foundation pile for installation in the seabed according to the invention is that the pile (29) with plugs (1) is detached from the towed set of piles and towed to the place of foundation installation. The remaining piles from towage set (30) are disconnected and hangs on the mooring buoys. In phase I, with the help of the valve control cable (34), the WR and R caps in the lower part of the pile (29) are annealed and the air is removed until the plugs WR and R are free to move inside the pile (29). In phase II, the pile (29) begins to upright automatically, the bottom of the pile submerges under the water surface, and the WR and R plugs lifts in the pile (29), displaced by the water flowing from the bottom. In phase III, the outer plug D at the top of the pile is hooked on the crane sling and the plugs D and WD in the top part of the pile are deflated by means of the valve control cable (34) until the caps D and WD can move freely inside the pile (29). In phase IV, the vertical pile (29) is gradually submerged, and the plugs (1) suspended on the crane are successively removed from the inside of the pile (29).

The use of a semi-rigid tow line according to the invention allows for safe towing of long sets of piles without the risk of a collision between the piles, and the pneumatic plugs guarantee the buoyancy of the pile-caps system, even in the event of damage to one of the plugs. In addition, plugs are actively used in the pile foundation procedure at the destination. The use of solutions according to the inventions allows to significantly reduce the costs of building offshore wind farms.

### Example I

A pile plug (1) with a rigid skeleton structure (2) and flexible sheathing (3) on the side surface of the plug body, the flexible sheathing being an airtight container provided with pneumatic valves (4). Flexible sheathing is made of synthetic rubber with flexible steel fiber reinforcement. The elastomeric material of the sheathing (3) of the plug (1) has a high coefficient of friction in relation to the material of the pile. The plug (1) has a flexible, cylindrical side surface (5) and spherical flexible bottoms (6) provided with towing eyes (7). Inside the plug (1) there is a pile venting pipe (14) closed with a pile venting valve (15), which connects the space inside the pile with the surroundings. The plug (1) has therein a cast iron ballast (16) for positioning the plug with respect to the pile and for balancing the cap horizontally. The pneumatic valves (4) of the plug (1) includes:
a main fill and drain valve (12);
a safety valve (13);
the control of the main valve (12) may be manual and pneumatic. The pneumatic system of the plug is placed outside the towed pile and is also equipped with a control apparatus (17) and is operated from the gallery (18). The flexible sheathing (3) on the surface of the bottom (6) located outside the pile is provided with a hermetic inspection hatch (19).

The rigid structure of the skeleton (2) of the plug (1) is placed inside the sheathing (3) and made of steel pipes in the form of a truss, to which are attached: ballast (16), venting pipe (14) and the edges of the bases (6) of the sheathing (3).

### Example II

A pile plug (1) with a rigid skeleton structure (2) and flexible sheathing (3) on the side surface of the plug body, the flexible sheathing being an airtight container with pneumatic valves (4). The flexible sheathing is made of natural rubber with elastic reinforcement made of aramid fibers. The elastomeric material of the sheathing (3) of the plug (1) has a high coefficient of friction in relation to the material of the pile. The plug (1) has rigid cone-shaped bottoms (6) provided with towing eyes (7). Inside the plug (1) there is a pile venting pipe (14) closed with a pile venting valve (15), which connects the space inside the pile with the surroundings. The plug (1) has therein a cast iron ballast (16) for positioning the plug with respect to the pile and for balancing the cap horizontally. The pneumatic valves (4) of the plug (1) includes:
a main fill and drain valve (12);
a safety valve (13);
the control of the main valve (12) may be manual and pneumatic. The pneumatic system of the plug is placed outside the towed pile and is also equipped with a control apparatus (17) and is operated from the gallery (18). The flexible sheathing (3) on the surface of the bottom (6) located outside the pile is provided with a hermetic inspection hatch (19).

The rigid structure of the skeleton (2) of the plug (1) is placed inside the sheathing (3) and is made of steel bars in the form of a truss, to which the ballast (16), venting pipe (14), rigid bottoms and the edges of the bases (6) of the flexible sheathing (3) are attached.

### Example III

A pile plug (1) with a rigid skeleton structure (2) and flexible sheathing (3) on the side surface of the plug body, the flexible sheathing being an airtight container provided with pneumatic valves (4). Flexible sheathing is made of polyurethane with flexible carbon fiber reinforcement. The elastomeric material of the sheathing (3) of the plug (1) has a high coefficient of friction in relation to the material of the pile. The plug (1) has rigid bottoms (6), the bottom inside the pile is in the shape of a flat circle, and the outer bottom is in the shape of a cone. The bottoms (6) are provided with towing eyes (7). Inside the plug (1) there is a pile venting pipe (14) closed with a pile venting valve (15), which connects the space inside the pile with the surroundings. The plug (1) contains a ballast load made from iron ballast (16) for positioning the plug in relation to the pile and for balancing the cap horizontally. The pneumatic valves (4) of the cap (1) includes:
a main fill and drain valve (12);
a safety valve (13);
the control of the main valve (12) may be manual and pneumatic. The pneumatic system of the plug is placed outside the towed pile and is also equipped with a control apparatus (17) and is operated from the gallery (18). The flexible sheathing (3) on the surface of the bottom (6) located outside the pile is provided with a hermetic inspection hatch (19).

The rigid structure of the skeleton (2) of the cap (1) is placed inside the sheathing (3) and is made of steel bars in the form of a truss, to which the ballast (16), venting pipe (14), rigid bottoms and the edges of the bases (6) of the flexible sheathing (3) are attached.

### Example IV

The installation cradle (17) has a chassis frame (18) with a wheeled undercarriage (19) in which one pair of wheels is swivel. The swivel pair of wheels is connected to the steering system (20). Preferably, one pair of wheels connects the drive train (21) with the drive motor (22). On the chassis frame (18) there is a cradle (17) bed (23) in the shape of a half-cylindrical surface, symmetrically with the inside of the cylinder facing upwards. The internal diameter of the cylindrical surface is equal to the internal diameter of the pile in which the cap is to be installed, and the height of the cylinder is equal to the length of the cap (24) to be installed. On the inner surface of the cylindrical cradle (23), at the bottom edge of the cradle (23), there are five water nozzles (25) supplied from the water system (26) with a pressure pump (27), constituting an integral part of the installation cradle (17).

### Example II

The installation cradle (17) has a chassis frame (18) with a wheeled undercarriage (19), in which two pairs of wheels are freely swivel. On the chassis frame (18) there is a cradle (17) bed (23), in the shape of a fragment of a cylindrical surface, with the inner side of the cylinder facing up. The internal diameter of the cylindrical surface is equal to the internal diameter of the pile in which the cap is to be installed, and the height of the cylinder is greater than the length of the cap (24) to be installed. On the inner surface of the cylindrical bed (23), nozzles (25) of water supplied from an external water installation together with a pressure pump are evenly distributed over the entire surface.

### Example V

The installation cradle (17) has a chassis frame (18) with a wheeled undercarriage (19), consisting of 5 pairs of swivel wheels. On the chassis frame (18) there is a cradle (17) bed (23) in the shape of a fragment of a cylindrical surface with the inner side of the cylinder facing upwards. The internal diameter of the cylindrical surface is equal to the internal diameter of the pile in which the cap is to be installed, and the height of the cylinder is not less than the length of the installed cap (24). On the inner surface of the cylindrical bed (23), nozzles (25) of water supplied from an external water installation together with a pressure pump are evenly distributed over the entire surface.

### Example VI

An installation cradle (17) with a bed diameter (23) equal to the pile diameter (29) is placed axially at the pile base (29), and a pneumatic plug (1) of the pile (17) is placed in the bed (23) in a known manner, using any lifting device. Air is pumped inside the plug (1) to a pressure not exceeding 120 kPa. Water is pumped into the water installation (26) and the water flow through the nozzles (25) is started. When the water pumped through the nozzles (25) begins to flow into the pile (29), the plug (1) is left to stabilize its position and moves into the pile (29) and increases the pressure inside the cap (1) to tightly fill the inside of the pile (29) with a plug (1). A hydraulic cylinder (16) is used for the displacement. Another advantageous solution is when a flexible tow-line (17) is used to move the plug (1) into the pile, through which the plug (1) is pulled from the end of the pile opposite to the cradle (17).

### Example VII

An installation cradle (17) with a bed diameter (23) equal to the diameter of the pile (29) is placed axially at the pile base (29), and a pneumatic (1) of the pile (29) is placed in the bed (23) in a known manner, using any lifting device. Air is pumped into the plug (1) to a pressure of not less than 120 kPa. Water is pumped into the water installation (26) and the water flow through the nozzles (25) is started. When the water pumped through the nozzles (25) begins to flow into the pile (29), the plug (1) is left to stabilize its position and moves into the pile (29) and increases the pressure inside the plug (1) to tightly fill the inside of the pile (29) with a plug (1). A flexible tow-line (28) is used to move the plug (1) into the pile, through which the plug (1) is pulled from the end of the pile opposite to the cradle (17).

### Example VIII

The towing set (30) has a steel tendon (31) in the form of a steel rope, covered with a cylinder-shaped elastomer shield (32). The cylindrical shield (32) is made of flexible polyurethane reinforced with glass fibre. The wall thickness of the cylinder and the reinforcement give the shield (32) considerable rigidity. At the ends of the tendon (31) of the towing set (30), bumpers (33) of the shield (32) are located. The bumpers are circular discs with an outer diameter greater than the outer diameter of the shield (32).

The tendon (31) at its ends has hook loops and shackles enabling the towing set (30) to be attached to the towing ship and the towed pile on the other side.

### Example IX

The towing set (30) has a steel tendon (31) in the form of a steel chain, covered with an elastomeric shield (32) in the shape of a cylinder. The cylindrical shield (32) is made of elastic rubber reinforced with polyamide fibre. The wall thickness of the cylinder and the reinforcement give the shield (32) considerable rigidity. At the ends of the tendon (31) of the towing set (30), bumpers (33) of the shield (32) are located. The bumpers are circular discs with an outer diameter greater than the outer diameter of the shield (32). The tendon (31) at its ends has shackles attached directly to the links of the chain enabling the towing set (30) to be attached to the tug and the towed pile on the other side.

### Example X

Inside the foundation pile (29), 72 m long and 9 m in diameter at the bottom and 7.98 m at the top, 4 pieces of plugs (1) are introduced using the installation cradle (17):
D—with a volume/displacement of −300 m³
WD—with a volume/displacement of −370 m³
WR—with a volume/displacement of −370 m³
R—with a volume/displacement of −370 m³

connected with each other by a flexible tow-line (28) and a cable controlling the operation of the valves (34). The plugs (1) are placed in pairs near the ends of the pile (29). The pressure inside the plug (1) is increased until the inside of the pile (29) is tightly filled. At one end of the pile (29), at least 2 towing sets (30) are attached to the hitch (35), the pile is watered and the other end of the towing sets (30) is attached to the tug. At the other end of the pile (29), at least 2 towing sets (30) are attached to the hitch (35), the other ends of which are attached to another towed pile provided with caps (1) and launched. The set of piles (29) connected by the semi-rigid towing sets (30) is towed to the installation site.

### Example XI

Inside the foundation pile (29), 90 m long and 11 m in diameter at the bottom, and 9 m at the top, 4 pieces of plugs (1) are introduced using the installation cradle (17):
D—with a volume/displacement of −370 m³
WD—with a volume/displacement of −450 m³
WR—with a volume/displacement of −450 m³
R—with a volume/displacement of −450 m³

connected with each other by a flexible tow-line (28) and a cable controlling the operation of the valves (34). The plugs (1) are placed in pairs near the ends of the pile (29). The pressure inside the plug (1) is increased until the inside of the pile (29) is tightly filled. At one end of the pile (29), at least 2 towing sets (30) are attached to the hitch (35), the pile is watered and the other end of the towing units (30) is attached to the tug. At the other end of the pile (29), at least 2 towing sets (30) are attached to the hitch (35), the other ends of which are attached to another towed pile provided with plugs (1) and launched. The set of piles (29) connected by the semi-rigid towing sets (30) is towed to the installation site.

### Example XII

The pile (29) with plugs (1) is disconnected from the towed set of piles and is towed to the place of foundation installation site. The remaining piles from the towage set (30) are disconnected and hangs on the mooring buoys. In phase I, with the help of the valve control cable (34), the WR and R caps in the lower part of the pile (29) are deflated and the air is removed until the caps WR and R are free to move inside the pile (29). In the second phase the pile (29) begins to upright automatically, the bottom of the pile is submerged under the water surface, and the plugs WR and R lifts in the pile (29), displaced by the water flowing from below. In phase III, the outer plug D at the top of the pile is hooked on the crane sling and the caps D and WD in the top part of the pile (29) are annealed by the cable controlling the operation of the valves (34) and the air until the caps D and WD can move freely inside the pile (29). In phase IV, the vertical pile (29) is gradually submerged, and the plugs (1) suspended on the crane are successively removed from the inside of the pile (29). Phase V is a pile placed on the bottom, which is hammered into the seabed with the help of a vibrating head. The plugs (1) removed from the pile (29) are hung on the mooring buoy until the plugs (1) and towing sets (30) are towed to the place of reinstallation.

1. A transport cap for a sea foundation pile for transporting piles using a floating towing method, the transport cap comprising:
a self-buoyant plug having a rigid skeleton structure (2) and a flexible sheathing (3) at least on a side surface of the plug,
wherein the flexible sheathing is an airtight container equipped with pneumatic valves (4).

2. The transport cap according to claim 1, wherein the flexible sheathing is made of an elastomeric material with an elastic reinforcement made of fibres, the fibres are selected from the group consisting of metal, textile, carbon, glass, and wherein the textile fibres are made of natural or synthetic fibres.

3. The transport cap according to claim 2, wherein the elastomer sheathing material (3) is made of a material with a high friction selected from the group consisting of natural rubber, synthetic rubber, and polyurethane.

4. The transport cap according to claim 1, wherein the plug (1) has a cylindrical flexible side surface (5) and a spherical flexible bottom (6) provided with towing eyes (7).

5. The transport cap according to claim 1, wherein the plug (1) has a cylindrical flexible side surface (5) and rigid bottoms (8), wherein the bottom is flat (9), conical (10), or spherical (11).

6. The transport cap according to claim 1, wherein inside the plug (1) there is a pile vent pipe (14) closed with a pile vent valve (15), the pile vent valve (15) connects a space inside the pile with the surroundings.

7. The transport cap according to claim 1, wherein the plug (1) includes a ballast load (16) for positioning the transport cap with respect to the pile and for balancing the plug horizontally.

8. The transport cap according to claim 1, wherein the pneumatic valves (4) of the plug (1) include:
a main fill and a drain valve (12);
a safety valve (13);
wherein the control of the main valve (12) is manual or pneumatic.

9. The transport cap according to claim 1, wherein the rigid skeleton structure (2) of the cap (1) is placed inside the sheathing (3) and is made of metal sections in a form of a truss, to which the ballast (16), the vent pipe (14), and the edges of the sheathing (3) bases (6) are attached.

10. An installation cradle for a transportation cap of a sea foundation pile, the installation cradle comprising:
a chassis frame (18) with a wheeled undercarriage (19), wherein at least one pair of wheels is swivel, and
a cradle bed (23) located on the chassis frame (18), the cradle bed having a of a fragment of a cylindrical surface, with an inner side of the cylinder facing upwards, an internal diameter of the cylindrical surface is equal to an internal diameter of the foundation pile in which the cap is to be installed, and
wherein a height of the cylindrical surface more than a length of an installed cap (24), wherein at least one nozzle (25) is placed on the inner surface of the bed (23), wherein water is supplied from a water installation (26) by a pressure pump (27).

11. The installation cradle according to claim 10, wherein the swivel pair of wheels is connected to the steering system (20).

12. The installation cradle according to claim 10, wherein one pair of the wheels is connected to the drive train (21) with a drive motor (22).

13. The installation cradle according to claim 10, wherein the water installation (26) and the pressure pump is an integral part of the installation cradle (17).

14. A method for installing a transport cap inside a foundation pile using an installation cradle, the method comprising the steps of:
placing axially the installation cradle (17) having a bed diameter (23) equal to a pile diameter (29) at the pile base (29 using a lifting device,
placing a pneumatic plug (1) of the pile (17),
pumping air inside the plug (1) to a pressure not less than 10% higher from a current atmospheric pressure surrounding the plug (1), and
pumping water into a water system (26);
flowing the water through nozzles (25);
wherein when the water pumped through the nozzles (25) begins to flow into the pile (29), the transport the cap (1) stabilizes in position and moves into the pile (29) and pressurizes inside the transport cap (1) to seal the inside of the pile (29) with the plug (1).

15. The method according to claim 14, wherein a hydraulic cylinder (16) is used for sliding.

16. The method according to claim 14, wherein a flexible tow-line (17) is used to move the plug (1) into the pile, through which the cap (1) is pulled from the end of the pile opposite to the cradle (17).

17. A towing set for sea foundation piles provided with a tendon and catches comprising:
a steel tendon (31) covered with a cylinder-shaped elastomeric shield (32);
wherein the cylindrical shield (32) is made of a flexible material optionally reinforced with fibres;
wherein at the ends of the steel tendon (31) have bumpers (33) of the shield (32);
wherein the tendon (31) has at the ends catch elements in the form of hooks or shackles enabling the towing set (30) to be attached to the towing ship and the towed pile on the other side.

18. The towing set according to claim 17, wherein the steel tendon is made of steel rope.

19. The towing set according to claim 17, wherein the tendon is in the form of a steel chain.

20. The towing set according to reservation 17, wherein the shield (32) is made of rubber.

21. The towing set according to claim 17, wherein the shield (32) is made of polyurethane.

22. The towing set according to claim 17, wherein the bumpers are discs with an outer diameter greater than the outer diameter of the shield (32).

23. A method for towing foundation piles over the sea surface with a displacement behind the tug, the method comprising the steps of:
introducing caps inside of a foundation pile (29) by using an installation cradle (28);
connecting the caps with each other by a flexible tow-line (28) and a cable controlling the operation of the valves (34), the caps (1) are placed in pairs near ends of the pile (29) and the pressure inside the cap (1) is increased to tightly fill the inside of the pile (29), then at one end of the pile (29), at least 1 towing set (30) is attached to the catch (35), the pile is watered and the other end of the towing set (30) is attached to the tug, then at the other end of the pile (29) to the hitch (35), possibly at least 1 towing set (30) is attached to the other end of the towing pile provided with caps (1) and launched, and then the set of piles (29) connected with the semi-rigid towing sets (30) are towed to the installation site.

24. A method of preparing a foundation pile for installation in the seabed towed by a wet method in a set of piles, behind the tug, the method comprising the steps of:
disconnecting pile (29) with caps (1) from a towed set of piles and towed a the place of foundation installation;
disconnecting a towing set (30) hunging on a mooring buoy; and
preparing a foundation by the following phases:
annealing a valve control cable (34), caps WR and R in a lower part of the pile (29);
removing the air until the caps WR and R are free to move inside the pile (29);
beginning to upright the pile (29) automatically, the bottom of the pile plunges under the water surface, and the caps WR and R lift inside the pile (29), displaced by the water flowing from the bottom;
catching an outer cap D at the top of the pile with a crane sling and the caps D and WD in the upper part of the pile (29) are annealed by means of the valve control cable (34) and the air until the caps D and WD can freely slide inside the pile (29);
gradually submerging the vertical pile (29) and suspending the caps (1) on the crane are successively removed from the inside of the pile (29);
vertically placing the pile (29) on the seabed.
